(19) United States
(12) Patent Application Publication
(10) Pub. No.: US 2011/0246930 A1
(43) Pub. Date: Oct. 6, 2011

(54) CONTENT RECEIVER AND CONTENT SENDING METHOD

(75) Inventor: Naoki YAMANASHI, Tokyo (JP)

(73) Assignee: Kabushiki Kaisha Toshiba, Tokyo (JP)

(21) Appl. No.: 12/939,980

(22) Filed: Nov. 4, 2010

(30) Foreign Application Priority Data
Mar. 30, 2010 (JP) 2010-077646

(51) Int. Cl. G06F 15/16; G06F 3/048

(52) U.S. Cl. 715/777; 709/219

(57) ABSTRACT

According to one embodiment, a content receiver includes a receiver and a display module. The receiver receives list information from a server that manages a plurality of contents to be delivered each in association with tag information in which information unique to the content is registered as a registered value with respect to each of a plurality of predetermined items. In the list information, identifiers each of which identifies each of the contents are associated with any of the predetermined items determined as a classification item. The display module classifies the identifiers contained in the list information based on the type of the registered value with respect to the classification item contained in the list information, and displays the identifiers on a display device.

### CROSS-REFERENCE TO RELATED APPLICATIONS

This application is based upon and claims the benefit of priority from Japanese Patent Application No. 2010-077646, filed on Mar. 30, 2010, the entire contents of which are incorporated herein by reference.

### FIELD

Embodiments described herein relate generally to a content receiver that receives content including a music file and an image file from a server on a network and a content receiving method.

### BACKGROUND

In recent years, a plurality of devices such as a television, a recorder, and the like connected to a network such as a local area network (LAN) share content including a music file, a video image file, and the like. For example, the guidelines issued by the digital living network alliance (DLNA) (hereinafter, “DLNA guidelines”) is known as a standard that allows various types of devices to share content.

In the DLNA guidelines, the basic system is formed of a digital media server (DMS) and a digital media player (DMP). The DMS stores content, while the DLNV reproduces the content stored in the DMS via a network. The DLNA guidelines use the hypertext transfer protocol (HTTP) to define the method of transmitting and controlling the reproduction of content.

The DMP is configured to send a GET request (HTTP GET) requesting for a list of contents to the DMS first, and obtain identifiers (file names) of contents stored in the DMS as list information. The DMP is configured to also send a GET request for information on tags attached to the contents, and obtain the tag information. The DMP displays the contents in a classified manner based on items (for example, title, album name, artist name, etc.) contained in the tag information for convenience to select content.

There have been proposed a variety of technologies for displaying file names in a classified manner in the DMP. For example, Japanese Patent Application Publication (KOKAI) No. 2009-267634 discloses a conventional technology in which the DMP has the function of the DMS, and thereby the device (DMP) is capable of displaying a list of contents provided from another device the DMS) and a list of contents stored therein in a classified manner (list display) in the same format.

According to the conventional technology, after list information is obtained, tag information is acquired from contents with file names contained in the list information. Classified display of the contents cannot be provided after the completion of the acquisition of the tag information. This delays response until the classified display because the conventional technology does not specifically take into account data communication for list display.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a digital living network alliance (DLNA) system according to an embodiment;

FIG. 2 is an exemplary block diagram of a hardware configuration of television (TV) illustrated in FIG. 1 in the embodiment;

FIG. 3 is an exemplary block diagram of a configuration of software executed by the hardware of the TV illustrated in FIG. 2 in the embodiment;

FIG. 4 is an exemplary schematic diagram of list information in the embodiment;

FIG. 5 is an exemplary schematic diagram of additional information in the embodiment;

FIGS. 6 and 7 are exemplary schematic diagrams of a content selection screen in the embodiment; and

FIG. 8 is an exemplary sequence diagram of operation until the content selection screen is displayed in the embodiment.

### DETAILED DESCRIPTION

Various embodiments will be described hereinafter with reference to the accompanying drawings. In general, according to one embodiment, a content receiver comprises a receiver and a display module. The receiver is configured to receive list information from a server that manages a plurality of contents to be delivered each in association with tag information in which information unique to the content is registered as a registered value with respect to each of a plurality of predetermined items. In the list information, identifiers each of which identifies each of the contents are associated with any of the predetermined items determined as a classification item. The display module is configured to classify the identifiers contained in the list information based on the type of the registered value with respect to the classification item contained in the list information, and display the identifiers on a display device.

According to another embodiment, there is provided a content receiving method comprising: a receiver receiving list information from a server that manages a plurality of contents to be delivered each in association with tag information in which information unique to the content is registered as a registered value with respect to each of a plurality of predetermined items, identifiers each of which identifies each of the contents being associated with any of the predetermined items determined as a classification item in the list information; and a display module classifying the identifiers contained in the list information based on a type of the registered value with respect to the classification item contained in the list information, and displaying the identifiers on a display device.

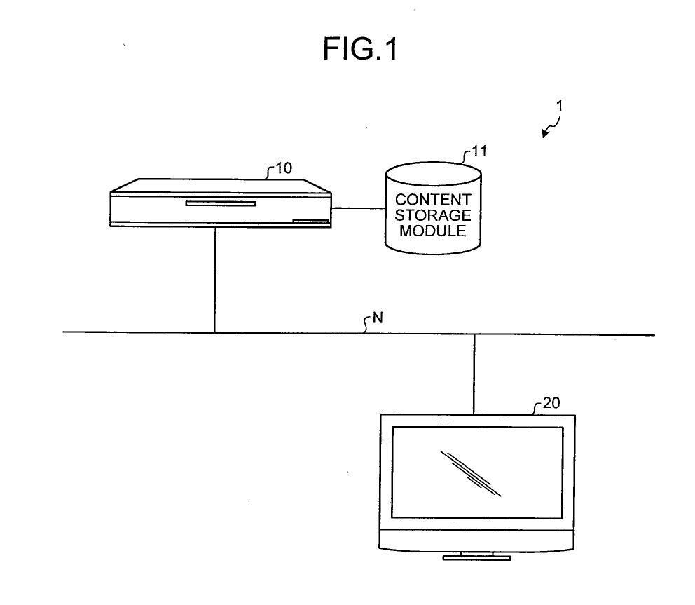

FIG. 1 is a schematic diagram of a digital living network alliance (DLNA) system 1 according to an embodiment. As illustrated in FIG. 1, the DLNA system 1 comprises a media server 10 and a television (TV) 20, which are connected to each other via a network N. The media server 10 and the TV 20 are information devices compliant with the DLNA guidelines. The number of information devices connected to the network N need not necessarily be as illustrated in FIG. 1.

The media server 10 has a digital media server (DMS) function to provide content stored in a content storage module 11 in response to a request from a digital media player (DMP) the TV 20). The media server 10 may be, for example, a recording device such as a hard disk drive (HDD) recorder, a server such as a personal computer (PC), or the like. The media server 10 stores music data and video data recorded thereon, and various types of data received from an external device in the content storage module 11 and manages them as contents to be delivered in association with tag information, which will be described later.

Contents stored in the content storage module 11 are electronic data that can be reproduced on the DMP such as music data and video data. Each of the contents is attached with tag information indicating information registered as a registered value unique to the content with respect to each of a plurality of predetermined items. For example, in the tag information of music data, information unique to the music data is registered with respect to each of predetermined items such as artist name, album name, total reproduction time, category name, and the like.

The media server 10 comprises a controller, a display module, an operation module, a storage module, and a communication module (all not illustrated). The controller comprises a central processing unit (CPU), a read only memory (ROM), a random access memory (RAM), and the like. The display module comprises a display device such as a liquid crystal display (LCD) or the like. The operation module comprises input devices such as a keyboard, a pointing device, and the like. The storage module comprises a storage device such as HDD, flash memory, and the like. The communication module controls communication with the DMP.

The storage module of the media server 10 stores in advance various programs to control the media server 10 and setting information. Incidentally, the content storage module 11 may be part of the storage module of the media server 10 or may be an external storage device connected to the media server 10.

The controller of the media server 10 executes the programs stored in the storage module, thereby controlling the overall operation of the media server 10. The controller of the media server 10 also executes a predetermined program stored in the storage module to realize the DMS function. Thus, the media server 10 provides the DMP with data on each content stored in the content storage module 11 in response to various types of requests received from the DMP.

More specifically, upon receipt of a hypertext transfer protocol (HTTP) get request from the DMP, the controller of the media server 10 reads information specified by the request from each content stored in the content storage module 11, and sends the information to the DMP. Besides, upon receipt of an HTTP get request for content to be reproduced from the DMP, the controller of the media server 10 reads the requested content from the content storage module 11, and sends the content to the DMP (stream distribution).

The TV 20 has the DMP function of accessing the media server 10 as the DMS to refer to and reproduce content stored in the media server 10. In the following, a description will be given of a configuration of the TV 20.

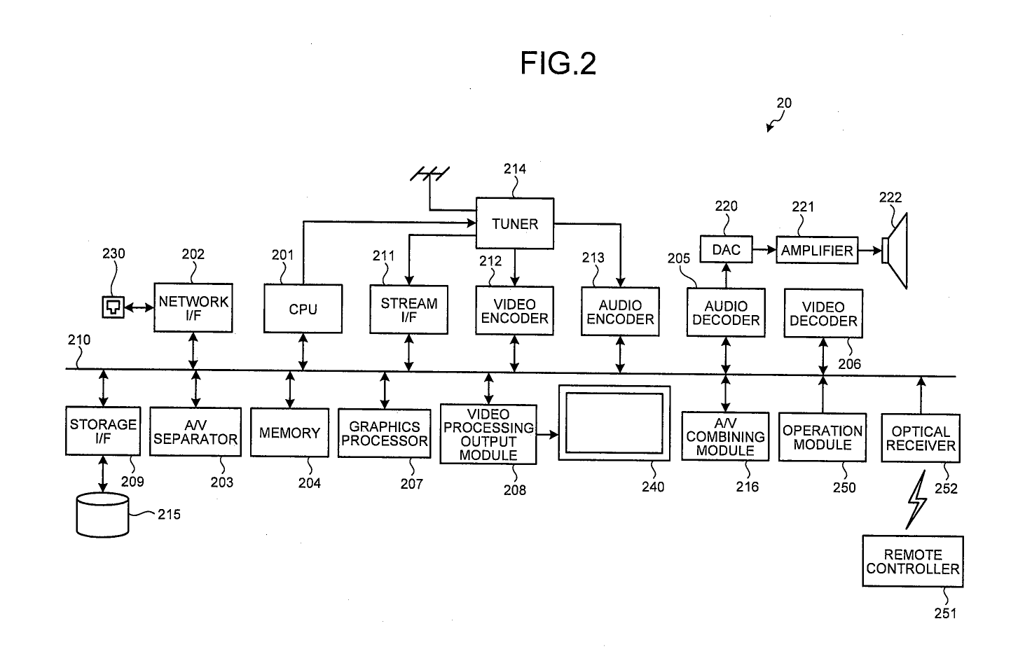

FIG. 2 illustrates an example of a hardware configuration of the TV 20. As illustrated in FIG. 2, the TV 20 comprises a CPU 201, a network interface (I/F) 202, an audio/video (A/V) separator 203, a memory 204, an audio decoder 205, a video decoder 206, a graphics processor 207, a video processing output module 208, a storage I/F 209, a bus 210, a stream I/F 211, a video encoder 212, an audio encoder 213, a tuner 214, a hard disk 215, an A/V combining module 216, a digital-to-analog converter (DAC) 220, an amplifier 221, a speaker 222, a terminal 230, a display panel 240, an operation module 250, a remote controller 251, and an optical receiver 252.

An analog video signal received by the tuner 214 is encoded by the video encoder 212. Meanwhile, an analog audio signal received by the tuner 214 is encoded by the audio encoder 213. The encoded video and audio signals are combined by the A/V combining module 216 into a stream. On the other hand, a digital video signal received by the tuner 214 is encoded by the video encoder 212. Meanwhile, an analog audio signal received by the tuner 214 is received through the stream I/F 211 as a stream in, for example, MPEG-2 transport stream (TS) format. The stream is stored in the hard disk 215 via the storage I/F 209.

The terminal 230 is an Ethernet (registered trade mark) terminal or the like to connect to the network N. Information from another device (the media server 10) on the network N is received by the TV 20 through the terminal 230 and the network I/F 202.

Under the control of the CPU 201, the A/V separator 203 separates a stream stored in the hard disk 215, a stream of content received from another device (the media server 10) through the terminal 230 and the network I/F 202, and the like into video data and audio data. The video data is decoded by the video decoder 206. The decoded video data is output from the video processing output module 208 as a video signal and is displayed on the display panel 240. Meanwhile, the audio data obtained by the A/V separator 203 is decoded by the audio decoder 205. The decoded audio data is output from the speaker 222 through the DAC 220 and the amplifier 221.

The CPU 201 executes various programs stored in the hard disk 215 or a storage medium such as ROM (not illustrated), thereby controlling the overall operation of the TV 20. More specifically, the CPU 201 generates, for example, a graphical user interface (GUI) display screen together with the graphics processor 207 and stores it in the memory 204 such as RAM. The CPU 201 reads the GUI display screen from the memory 204 as required and displays it on the display panel 240. Besides, upon receipt of an instruction to the TV 20 provided on the remote controller 251 through the operation module 250 or the optical receiver 252, the CPU 201 switches broadcast signals (channels) received by the tuner 214, detects input on the GUI display screen, or the like.

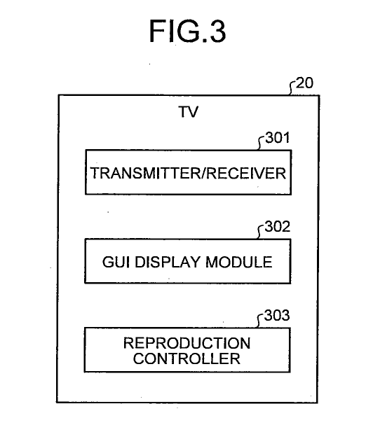

FIG. 3 is a block diagram of a configuration of software executed by the hardware (the CPU 201) of the TV 20. As illustrated in FIG. 3, the TV 20 comprises, as functional modules implementing the DMP function, a transmitter/receiver 301, a GUI display module 302, and a reproduction controller 303.

The transmitter/receiver 301 accesses the DMS (the media server 10) using HTTP and obtains a list of contents stored in the media server 10 or content to be reproduced.

More specifically, after recognizing the media server 10 through universal plug and play (UPnP), the transmitter/receiver 301 sends a GET request (hereinafter, “list information request”) upon first access to the media server 10 requesting for a file name as an identifier of each content stored in the media server 10 and a registered value registered in tag information of each content with respect to a predetermined classification item.

The term “classification item” as used herein refers to any item that constitutes tag information. The classification item is stored as setting information in a storage medium such as the hard disk 215. For example, among items contained in tag information, if “artist name” and “album name” are set as classification items, the transmitter/receiver 301 requests for a registered value registered in the tag information with respect to each of the items “artist name” and “album name”. The number and types of classification items may be arbitrarily set.

Upon receipt of a list information request from the TV 20, the controller of the media server 10 reads the file name of each content stored in the content storage module 11 and the registered value specified by the list information request, and sends them to the TV 20 as list information. The transmitter/receiver 301 stores the list information received from the media server 10 in the memory 204.

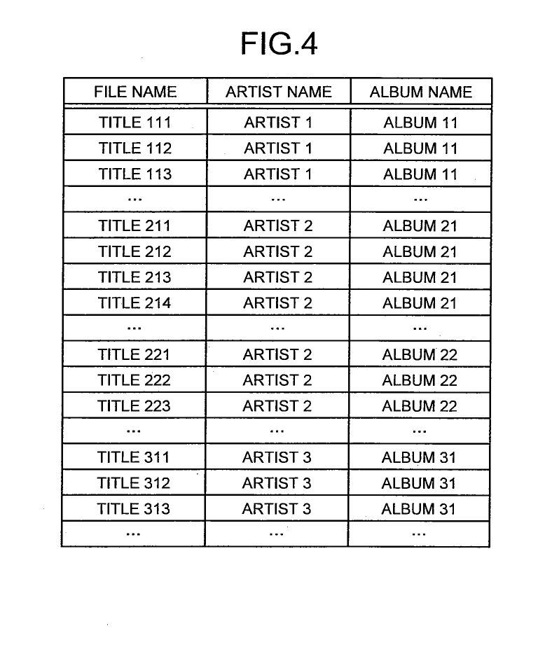

FIG. 4 schematically illustrates an example of list information stored in the memory 204. As illustrated in FIG. 4, as the list information, the file name of each content stored in the media server 10 is stored in association with a registered value with respect to each classification item. FIG. 4 illustrates by way of example “artist name” and “album name” as classification items among items that constitute the tag information. In the example of FIG. 4, the file name of each content is the same as the title of the content.

Upon receipt of a specific registered value through the GUI display module 302, the transmitter/receiver 301 reads a file name associated with the registered value from the list information. The transmitter/receiver 301 then sends a GET request (hereinafter, “additional information request”) requesting for tag information on content with the file name to the media server 10.

Upon receipt of the additional information request from the TV 20, the controller of the media server 10 reads tag information from the content with the file name specified by the additional information request. The controller of the media server 10 sends the tag information to the TV 20 as additional information. The transmitter/receiver 301 stores the additional information received from the media server 10 in the memory 204.

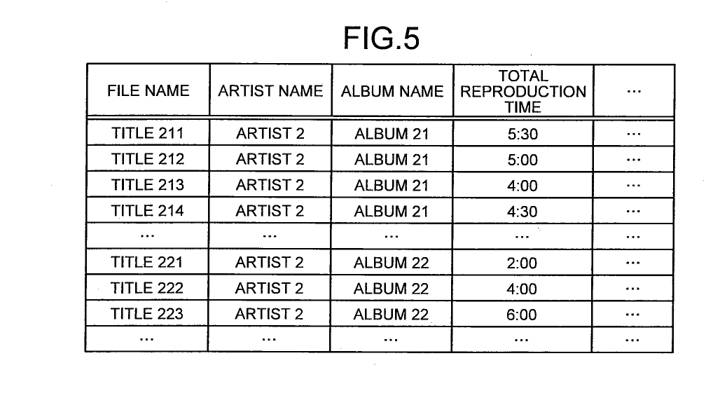

FIG. 5 schematically illustrates an example of additional information stored in the memory 204. As illustrated in FIG. 5, as the additional information, details of tag information of each content specified by an additional information request is stored. As the additional information, FIG. 5 illustrates by way of example tag information of each content related to a registered value “artist 2” registered for the classification item “artist name”. In this manner, as the additional information, only tag information containing a specific registered value is stored from among tag information of contents stored in the media server 10.

Upon receipt of an instruction that specifies specific content (file name) as an object to be reproduced from a list of contents displayed on a content selection screen, which will be described later, the transmitter/receiver 301 sends a GET request (hereinafter, “content delivery request”) requesting for the delivery of content corresponding to the file name to the media server 10.

Upon receipt of the content delivery request from the TV 20, the controller of the media server 10 reads content with the file name specified by the content delivery request from the content storage module 11, and sends the content to the TV 20 (stream distribution). The transmitter/receiver 301 outputs a stream of the content received from the media server 10 to the reproduction controller 303.

The GUI display module 302 is a functional module that displays contents stored in the media server 10 in a classified manner as wall as displaying GUI (hereinafter, “content selection screen”) on the display panel 240 to allow the selection of content to be reproduced.

More specifically, the GUI display module 302 generates, based on the type of a registered value with respect to each classification item contained in list information, a “tab” for the classification item and the type of the registered value and displays the tab on the display panel 290. Hereinafter, a tab generated for each classification item is referred to as “first classification tab”, while a tab generated for each registered value is referred to as “second classification tab”.

Upon receipt of the selection of a specific second classification tab from among second classification tabs displayed in the display panel 240, the GUI display module 302 reads information such as a file name associated with a registered value corresponding to the second classification tab from list information. The GUI display module 302 displays the information on the display panel 240 in association with the selected second classification tab.

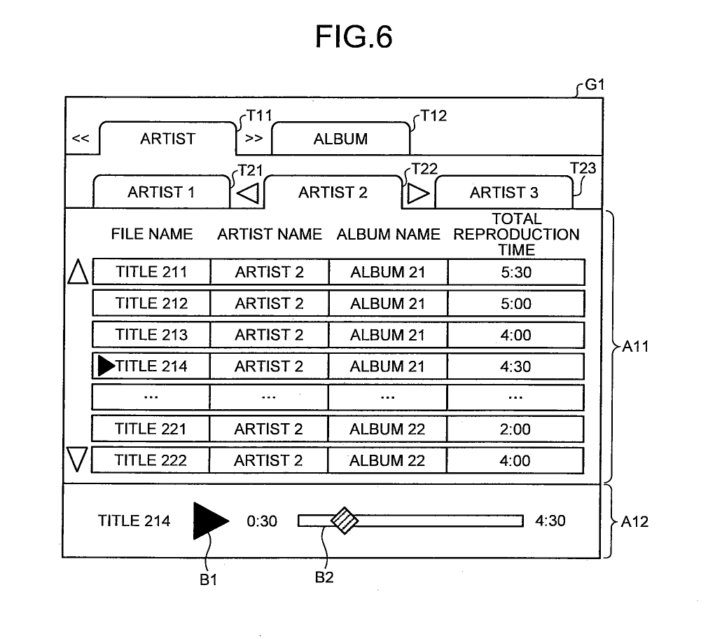

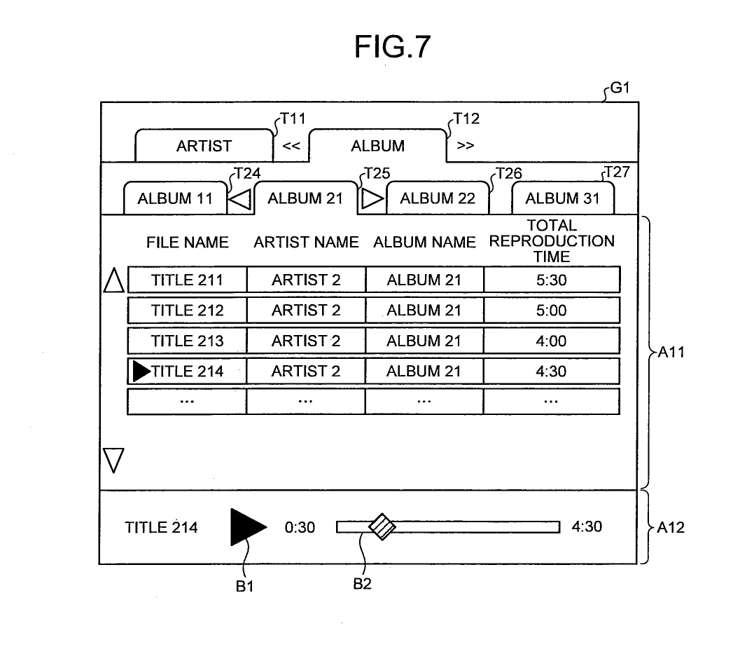

FIGS. 6 and 7 illustrate examples of a content selection screen G1 displayed on the display panel 240. FIGS. 6 and 7 illustrate by way of example “artist name” and “album name” as classification items among a plurality of items that constitute tag information.

As illustrated in FIGS. 6 and 7, the GUI display module 302 generates first classification tabs T11 and T12 with respect to classification items “artist name” and “album name”, and displays them on the content selection screen G1.

The GUI display module 302 displays a second classification tab generated for the type of each registered value contained in list information on the content selection screen G1 in association with a selected first classification tab.

FIG. 6 illustrates an example in which the first classification tab T11 is selected. In this case, the GUI display module 302 displays second classification tabs T21 to T23 generated for registered values (artists 1 to 3) belonging to the classification item “artist name” of the first classification tab T11 on the content selection screen G1. If the first classification tab T12 is selected in the case of FIG. 6, as illustrated in FIG. 7, the GUI display module 302 displays second classification tabs T24 to T27 generated for registered values (albums 11, 21, 22, and 31) belonging to the classification item “album name” of the first classification tab T12 on the content selection screen G1. In this manner, the GUI display module 302 switches second classification tabs displayed on the content selection screen G1 according to the classification item of a selected first classification tab.

The content selection screen G1 includes an area A11 in which are displayed file names of contents corresponding to classification conditions defined by a combination of a first classification tab and a second classification tab. More specifically, upon receipt of the selection of a second classification tab through the operation module 250 or the optical receiver 252, the GUI display module 302 reads information such as file names associated with a registered value indicated by the second classification tab from list information. The GUI display module 302 displays the read information in the area A11 in association with respect to the same content.

FIG. 6 illustrates an example in which the second classification tab T22 indicating the registered value “artist 2” is selected. In this case, the GUI display module 302 reads information such as a file name, an artist name, and an album name associated with the registered value of the second classification tab T22 “artist 2” from list information. The GUI display module 302 then displays the information in the area A11 in association with the second classification tab T22. Incidentally, all or part of the character string of the file name may be displayed. For example, the extension contained in the file name may not be displayed, or, if the maximum number of displayable characters is determined (for example, 20 bytes, etc.), the maximum number of characters from the top of the file name may be displayed.

FIG. 7 illustrates an example in which the second classification tab T25 indicating a registered value “album 21” is selected. In this case, the GUI display module 302 reads information such as a file name, an artist name, and an album name associated with the registered value of the second classification tab T25 “album 21” from list information. The GUI display module 302 then displays the information in the area A11 in association with the second, classification tab T25. In this manner, the area A11 displays information on contents corresponding to classification conditions defined by a combination of a first classification tab and a second classification tab.

A second classification tab need not necessarily be selected through the operation module 250 or the optical receiver 252. For example, first and second classification tabs selected upon completion of the previous display of the content selection screen G1 or first and second classification tabs set as default (for example, first and second classification tabs displayed on the leftmost side of the content selection screen G1) maybe stores as setting information such that the first and second classification tabs can be automatically selected at the start of displaying the next content selection screen G1.

The information displayed in the area A11 need not necessarily be read from list information, and information (additional information) newly obtained from the media server 10 may be displayed in the area A11. In this case, the GUI display module 302 notifies the transmitter/receiver 301 of a registered value indicated by a selected second classification tab to obtain tab information (additional information) attached to each content related to the registered value from the media server 10, thereby displaying the additional information in the area A11. If additional information is used, only the additional information may be displayed, or the additional information may be displayed in combination with information contained in list information (see “total reproduction time” in FIGS. 6 and 7).

When pieces of information are displayed in the area A11, preferably, the pieces of information are sorted according to the classification item of a selected first classification tab. For example, if the first classification tab T11 (artist) is selected, preferably, pieces of information to be displayed are sorted in the ascending order of the file names, and then displayed in the area A11. Meanwhile, if the first classification tab T12 (album) is selected, preferably, pieces of information to be displayed are sorted in the ascending order of the track numbers or the file names, and then displayed in the area A11.

Further, a tab (all display tab) may be displayed on the content selection screen G1 to display all file names contained in list information. In this case, upon receipt of the selection of the all display tab, the transmitter/receiver 301 displays all information contained in list information.

The content selection screen G1 further includes an area A12 in which are displayed a reproduction button B1 for specifying content (a file name) selected from the area A11 as the abject to be reproduced, reproduction time, a time bar B2 indicating the reproduction time of the content, and the like. When the reproduction button B1 is pressed after a file name is selected from those displayed in the area A11, the GUI display module 302 outputs instruction information that specifies content with the file name as the object to be reproduced to the transmitter/receiver 301. Then, the GUI display module 302 changes the reproduction time and the slider position of the time bar B2 in the area A12 according to the position of the stream reproduced by the reproduction controller 303. In the examples of FIGS. 6 and 7, content with “title 214” is the object to be reproduced.

Referring back to FIG. 3, the reproduction controller 303 is a functional module that reproduces a stream received through the transmitter/receiver 301. Incidentally, if content to be reproduced requires the screen display of video data or the like, the reproduction controller 303 displays a screen display area in the content selection screen G1 or displays it superimposed on the content selection screen G1, thereby displaying a reproduction screen for the stream in the area.

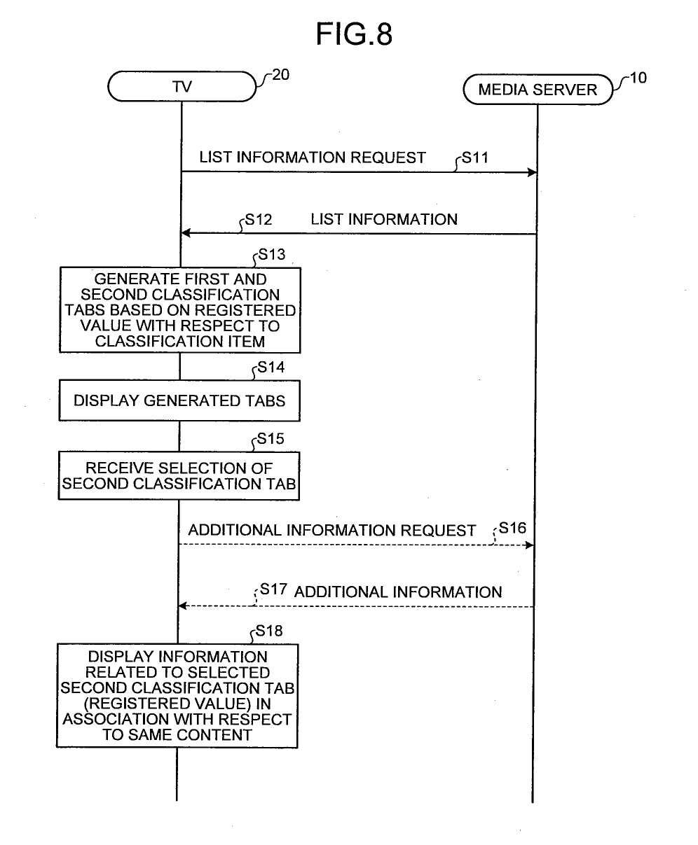

A description will be given of the operation of the TV 20 in the DLNA system 1 configured as above. FIG. 8 is a sequence diagram of the operation until the content selection screen is displayed. It is assumed herein that the TV 20 completes the recognition of the media server 10.

First, the transmitter/receiver 301 of the TV 20 sends a list information request for a file name of each content stored in the media server 10 and a registered value registered in the tag information of the content with respect to a predetermined classification item to the media server 10 as the DNS (S11).

Upon receipt of the list information request, the controller of the media server 10 reads the file name of each content stored in the content storage module 11 and the registered value specified by the list information request with respect to the classification item, and sends them to the TV 20 as list information (S12). Upon receipt of the list information, the transmitter/receiver 301 of the TV 20 stores it in the memory 204.

Next, the GUI display module 302 of the TV 20 generates, based on the type of the registered value with respect to the classification item contained in the list information, first and second classification tabs for classification display (S13). The GUI display module 302 then generates a content selection screen including the tabs generated at S13 and displays it on the display panel 240 (S14).

If one of the second classification tabs is selected automatically or through the operation module 250 or the optical receiver 252, the GUI display module 302 receives the selection of the second classification tab (S15). The GUI display module 302 reads information such as file names associated with a registered value corresponding to the second classification tab from the list information. The GUI display module 302 then displays the read information in the area A11 in association with respect to the same content as illustrated in FIGS. 6 and 7 (S18).

If it is set to obtain additional information according to the selection of a second classification tab, the GUI display module 302 notifies the transmitter/receiver 301 of the registered value corresponding to the second classification tab selected at S15. The transmitter/receiver 301 reads a file name associated with the registered value notified by the GUI display module 302 from the list information. The transmitter/receiver 301 then sends an additional information request for tag information attached to content with the file name to the media server 10 (S16).

Upon receipt of the additional information request from the TV 20, the controller of the media server 10 reads tag information from the content with the file name specified by the additional information request. The controller of the media server 10 sends the tag information to the TV 20 as additional information (S17). The transmitter/receiver 301 of the TV 20 stores the additional information received from the media server 10 in the memory 204.

The GUI display module 302 of the TV 20 displays various types of information contained in the additional information received from the media server 10 in the area A11 in association with respect to the same content (S18).

As described above, according to the embodiment, a file name of each content stored in the media server 10 and, among tag information attached to the content, a registered value of a classification item are obtained (received) as list information. Contents (file names) are classified based on the type of the registered value of the classification item contained in the list information to be displayed. With this, the contents can be displayed in a classified manner using only the list information obtained by one access. This enables efficient classification display of contents stored in the media server 10.

If it is set to obtain additional information from the media server 10 according to the selection of a second classification tab, tag information can be obtained for content corresponding to a registered value of the selected second classification tab. Thus, tag information unnecessary for classification display is not received, which reduces the amount of data transmitted/received at one time.

Various modifications, alterations, and additions may be introduced into the arrangement of parts previously described in the embodiment.

For example, while the embodiment describes an example in which classification display is performed using a tab, it is not so limited. Contents may be sorted with respect to each classification item or may be subjected to filtering to be displayed in a classified manner. Further, a button may be displayed in place of the tab. In this case, upon receipt of the selection (depression) of the button, the GUI display module 302 reads information such as a file name and the like corresponding to classification condition (registered value) defined by the button from list information, and displays the information in a list on the content selection screen. Still further, a list box maybe displayed in place of the tab. In this case, upon receipt of a classification condition from the list box, the GUI display module 302 reads information such as a file name and the like corresponding to the classification condition (registered value) from list information, and displays the information in a list on the content selection screen.

While the embodiment is described above as being applied to the TV 20, this is by way of example and not of limitation. The embodiment may be applied to a setup-box DMP provided with the display panel 240 as an external device, a digital media adaptor (DMA) without functional modules related to the reception of broadcast waves and the display panel 240, and the like.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content receiver comprising:
a receiver configured to receive list information from a server that manages a plurality of contents to be delivered each in association with tag information in which information unique to the content is registered as a registered value with respect to each of a plurality of predetermined items, identifiers each of which identifies each of the contents being associated with any of the predetermined items determined as a classification item in the list information; and
a display module configured to classify the identifiers contained in the list information based on a type of the registered value with respect to the classification item contained in the list information, and display the identifiers on a display device.

2. The content receiver of claim 1, wherein the display module is configured to display a first classification tab for the classification item and a second classification tab for the type of the registered value, and display any of the identifiers in the list information that satisfies a classification condition defined by a combination of the first classification tab and the second classification tab in association with the second classification tab.

3. The content receiver of claim 2, further comprising a first receiving module configured to receive a selection of the first classification tab and the second classification tab, wherein
when the first receiving module receives the selection of the first classification tab, the display module changes the second classification tab displayed on the display device according to the classification item of the first classification tab.

4. The content receiver of claim 3, wherein, when the first receiving module receives the selection of the second classification tab, the display module displays any of the identifiers in the list information, which is related to the registered value of the second classification tab, in association with the second classification tab.

5. The content receiver of claim 3, wherein
when the first receiving module receives the selection of the second classification tab, the receiver receives tag information of content corresponding to any of the identifiers in the list information, which is associated with the registered value of the second classification tab from the server, and
the display module is configured to display the tag information received by the receiver on the display device in association with the second classification tab.

6. The content receiver of claim 1, wherein
the receiver is configured to receive content corresponding to an identifier as an object to be reproduced among the identifiers displayed on the display device, and
the content receiver further comprises a reproducer configured to reproduce the content received by the receiver.

7. The content receiver of claim 1, wherein
the server is a media server compliant with digital living network alliance guidelines, and
the receiver is configured to access the server using a hypertext transfer protocol.

8. The content receiver of claim 1, further comprising a display panel as the display device.

9. A content receiving method comprising:
a receiver receiving, by a receiver, list information from a server that manages a plurality of contents to be delivered each in association with tag information in which information unique to the content is registered as a registered value with respect to each of a plurality of predetermined items, identifiers each of which identifies each of the contents being associated with any of the predetermined items determined as a classification item in the list information; and
a display module classifying, by a display module, the identifiers contained in the list information based on a type of the registered value with respect to the classification item contained in the list information, and displaying the identifiers on a display device.
